(19) United States
(12) Patent Application Publication
(10) Pub. No.: US 2022/0025103 A1
(43) Pub. Date: Jan. 27, 2022

(54) PUR-/PIR RIGID FOAMS CONTAINING POLYESTER POLYOLS WITH REDUCED FUNCTIONALITY

(71) Applicant: Covestro Intellectual Property GmbH & Co. KG, Leverkusen (DE)

(72) Inventors: Hartmut Nefzger, Pulheim (DE); Bolko Raffel, Dormagen (DE); Marcel Schornstein, Neuss (DE); Torsten Hagen, Dortmund (DE)

(21) Appl. No.: 17/297,494

(22) PCT Filed: Dec. 10, 2019
(86) PCT No.: PCT/EP2019/084319

§ 371 Date: May 27, 2021

(30) Foreign Application Priority Data
Dec. 14, 2018 (EP) 18212596.3

(51) Int. Cl. C08G 18/42; C08G 63/16; C08G 63/78

(52) U.S. Cl. CPC C08G 18/4238; C08G 63/16; C08G 2101/00; C08G 2110/0025; C08G 2110/0075; C08G 63/78

(57) ABSTRACT

The invention relates to a method for preparing polyester polyols containing monools, and to their use, in particular for preparing polyurethane/polyisocyanurate rigid foams (also referred to hereafter as PUR/PIR rigid foams) with improved fire performance.

The invention relates to a process for producing polyester polyols containing monools and to the use thereof in particular for producing rigid polyurethane/polyisocyanurate foams (hereinbelow also referred to as rigid PUR/PIR foams) having improved fire safety.

Rigid PUR/PIR foams are nowadays predominantly produced on the basis of aromatic polyester polyols since these have a positive effect on the flame retardancy and the thermal conductivity of the rigid PUR/PIR foams. Raw materials employed in the production of aromatic polyester polyols especially include phthalic acid, terephthalic acid and isophthalic acid and also anhydrides thereof. Polyether polyols and sometimes also aliphatic polyester polyols are occasionally also employed in addition to aromatic polyester polyols to improve the solubility characteristics of pentanes with regard to the aromatic polyester polyols or to reduce the brittleness of the isocyanurate-containing rigid PUR/PIR foams.

In the field of insulation sheet production polyester-based rigid PUR/PIR foams are in increasing demand. A quantitatively important polyester polyol is constructed from technical grade glutaric acid (mixture of 70-80% glutaric acid further containing adipic acid and/or succinic acid) and ethylene glycol.

The prior art also discloses co-use of the monofunctional building blocks, such as for example monofunctional acids, in polyester synthesis in order to reduce the average functionality of the resulting polyester polyols (see for example EP 1219653 A [0012] and WO 97/48747). Monobasic unsaturated fatty acids are mentioned as examples of such monofunctional building blocks but only monofunctional oleic acid is explicitly mentioned in each case. In terms of the functionality of the polyester polyols it is stated that this should be on average in the range between 1.8 and 8, preferably >2.

EP 1 924 356 B1 also discloses producing rigid PUR/PIR foams with polyesterols which have functionalities of 1.5-5 and employ as further starting materials not only polyfunctional alcohols and carboxylic acids but also hydrophobic substances. The hydrophobic substances are water-insoluble substances containing a nonpolar organic radical and at least one reactive group selected from hydroxyl, carboxylic acid, carboxylic ester or mixtures thereof. The equivalent weight of the hydrophobic materials is between 130 and 1000 g/mol. Employable substances include for example fatty acids, such as stearic acid, oleic acid, palmitic acid, lauric acid or linoleic acid, and also fats and oils such as for example castor oil, corn oil, sunflower oil, soybean oil, coconut oil, olive oil or tall oil. When the polyesters contain hydrophobic substances the proportion of the hydrophobic substances in the total monomer content of the polyester alcohol is preferably 1 to 30 mol %, particularly preferably 4 to 15 mol %. However, in terms of production of the polyesters containing such monofunctional hydrophobic building blocks EP 1 942 356 B1 and the prior art in general disclose only that they are to be produced by esterification of the starting products.

However, lowering the functionality of polyester polyols through use of monools would also be of interest. This would expand the possible raw material basis so that waste products from other syntheses for example could also be employed.

Even though the prior art mentions polyester polyols having number-average hydroxy functionalities (hereinbelow: F(OH)) between 1.0 and 2.0 no simple process by which the functionalities of monool-containing polyester polyols may be safely and reproducibly adjusted has hitherto existed. In particular the monools are for example on account of their often low boiling points or on account of their steam-volatility often completely or partially discharged in non-reproducible fashion (see for example WO 2010/139395 A) during a classical esterification reaction, i.e. upon application of vacuum, for example 200 mbar or else 100 mbar or else 10 mbar, and/or at high temperatures, for example 180° C. to 220° C., with the result that the functionality of the resulting polyester polyol cannot be reproducibly adjusted.

The present invention accordingly has for its object to provide a process for producing polyester polyols containing monools, in particular polyester polyols containing monools having number-average hydroxy functionalities of 1.00<F(OH)<2.00, by means of which the problems resulting from the prior art may be overcome and the polyols may be reproducibly produced.

The recited object was achieved by a multistep process for producing a polyester polyol PES-B having a number-average OH functionality of >1.00, preferably having a number-average OH functionality of >1.00 to <2.00, containing the steps of

a) complete reaction of at least one carboxyl compound selected from the group consisting of i) polyfunctional, preferably difunctional, carboxylic acids and ii) polyfunctional, preferably difunctional, hydroxyl-reactive carboxylic acid derivatives selected from the group consisting of carbonyl chlorides, alkyl carboxylates, hydroxy-functional carboxylic acids, lactones and carboxylic anhydrides with at least one polyol containing 2-8 hydroxy groups, preferably 2-3 hydroxy groups, particularly preferably 2-2.5 and in particular 2 hydroxyl groups to afford a polyester polyol PES-A, wherein in this step a) the ratio of the molar amount of hydroxyl groups [n(OH)ₐ] to the molar amount of carboxyl-equivalent groups [n(carboxy)ₐ] is:

n(OH)ₐ/n(carboxy)ₐ>1

and wherein the theoretically calculated hydroxyl number of the PES-A is determined from the polyester formulation by equating the employed hydroxyl end groups n(OH)ₐ and the employed carboxyl end groups/carboxyl-equivalent groups n(carboxy)ₐ. For example carboxylic anhydrides are included in the equation as having two carboxyl end groups, lactones as each having one hydroxyl end group and one carboxyl end group, alkyl esters of dicarboxylic acids as having two carboxyl end groups. Further details about determining the theoretical hydroxyl number are more particularly elucidated hereinbelow.

b) subsequent reaction of the polyester polyol PES-A obtained in step a) with a monofunctional alcohol (monool) to afford the PES-B,

wherein the ratio of the molar sum of the hydroxy groups of all reactant molecules employed in steps a) and b) to the molar sum of the employed carboxyl-equivalent groups is:

n(OH)_{reactant}/n(carboxy)_{reactant}>1.

In the context of the present patent application “carboxyl end groups”, “carboxyl-equivalent groups” and “carboxy functions” (together referred to as “n(carboxy)”) are to be understood as meaning those functional groups of carboxylic acids and carboxylic acid derivatives capable of reacting with a hydroxy group in an esterification reaction.

The first step a) comprises producing a polyester polyol PES-A from the carboxy-functional component and the polyol by means of a complete esterification reaction. In the context of the present patent application “complete esterification reaction” is to be understood as meaning that the esterification reaction is only discontinued when the acid number of the polyester polyol A is <3 mg KOH/g (preferably <1.5 mg KOH/g). The acid number may be determined according to DIN EN ISO 2114 (June 2002).

In a preferred embodiment the ratio of the reactants in step a) are chosen such that the theoretical hydroxyl number corresponds to the desired hydroxyl number of the polyester PES-A upon complete esterification of the components. The esterification reaction in step a) comprises initially charging and reacting by means of heating at least the reactants difunctional organic acid and difunctional alcohol in known fashion. The polyester polyols are normally produced without using a solvent. Discharging of the water of reaction in the solvent-free variant is preferably assisted by applying negative pressure, especially towards the end of the esterification. Pressures of 1 to 500 mbar are employed. However, esterification above 500 mbar is also possible. The discharging of the water of reaction may also be assisted by flushing with an inert gas, for instance nitrogen or argon. However, the esterification may also be carried out with addition of a solvent, in particular a water-entraining solvent (azeotropic esterification), such as for instance benzene, toluene or dioxane.

After complete esterification the actual hydroxyl number of the obtained polyester polyol is then determined, for example according to DIN 53240 (December 1971). If there are divergences from the theoretically calculated hydroxyl number as a consequence of unintended discharging of diol the hydroxyl number may be adjusted to the pre-calculated value by replenishment thereof, wherein in one variant diol replenished at this point is interesterified by application of elevated temperature, for example in the range from 160° C. to 240° C., over a relatively lengthy period of 12 to 4 hours, for example 170° C. and 10 hours or 180° C. and 6 hours or 200° C. and 5 hours, without application of vacuum, so that in respect of the oligomer distribution a Schulz-Flory distribution is obtained. In case of a very large divergence a renewed determination of the hydroxyl number and also the acid number and further replenishment of diol may follow until the measured hydroxyl number of the PES-A corresponds to the desired hydroxyl number.

The theoretically calculated hydroxyl number of the PES-A is determined from the polyester formulation by equating the employed hydroxyl end groups n(OH)ₐ and the employed carboxyl end groups/carboxyl-equivalent groups n(carboxy)ₐ as defined hereinabove. For example carboxylic anhydrides are included in the equation as having two carboxyl end groups, lactones as each having one hydroxyl end group and one carboxyl end group, alkyl esters of dicarboxylic acids as having two carboxyl end groups.

The moles of carboxyl end groups (optionally the carboxyl-equivalent groups) are then subtracted from the moles of excess hydroxyl groups [n(OH)ₐ−n(Carboxy)ₐ] to obtain the number of moles of hydroxyl groups unreactable due to lack of reaction partners. Calculating the difference between the (excess of) hydroxyl groups and the (deficiency of) carboxyl end groups (in the above sense) gives the number of hydroxyl end groups remaining in the completed polyester polyol:

n(OH)_{PES-A}=n(OH)ₐ−n(carboxy)ₐ

Further accounting for the mass of condensate removed by distillation, for example 2 moles of water per employed mole of dicarboxylic acid, gives the mass of the polyester polyol batch and thus also the number of moles of hydroxyl end groups normalized to 1 kg of product, n(OH)_{PES-A}/kg. Since the hydroxyl end groups are equivalent to KOH the theoretical hydroxyl number [g KOH/kg] is obtained by multiplying the number of moles of hydroxyl end groups normalized to 1 kg of product [mol/kg] by 56.1 g KOH/mol: Hydroxyl number=n(OH)_{PES-A}/kg*56.1 g KOH/mol.

The hydroxyl number of the polyester PES-B may then be analogously calculated from

n(OH)_{PES-B}=n(OH)_{reactant}−n(Carboxy)_{reactant}.

The carboxyl compounds employed in step a) are selected from the group consisting of i) polyfunctional, preferably difunctional, carboxylic acids and ii) polyfunctional, preferably difunctional, hydroxy-reactive carboxylic acid derivatives, for example, carbonyl chlorides, alkyl carboxylates, hydroxy-functional carboxylic acids, lactones and carboxylic anhydrides. The free acids or their anhydrides are especially employed. Preference is given to compounds derived from an at least difunctional organic acid and especially selected from the group consisting of glutaric acid, succinic acid, adipic acid, terephthalic acid, phthalic acid, isophthalic acid or combinations thereof, in particular glutaric acid, succinic acid, adipic acid, phthalic acid. The latter are particularly preferably combined with ethylene glycol and/or diethylene glycol.

In the subsequent second step b) the monool is interesterified in identical fashion by application of elevated temperature, for example in the range from 160° C. to 240° C., over a relatively lengthy period of 12 to 4 hours, for example 170° C. and 10 hours or 180° C. and 6 hours or 200° C. and 5 hours, without application of vacuum, to obtain the polyester polyol PES-B having the desired functionality and hydroxyl number. Step b) is particularly preferably implemented without solvent and/or entraining agent. This second step ensures that it is possible for the monools which in a classical single-step esterification would be entirely or partially discharged in non-reproducible fashion on account of their often low boiling point or else on account of their steam-volatility but in some cases also on account of azeotrope formation with diols during a classical esterification reaction, i.e. upon application of vacuum, for example 200 mbar or else 100 mbar or else 10 mbar, to be completely reacted.

The reaction of the monool with the polyester polyol PES-A in the second step b) affords the polyester polyol PES-B which has a lower number-average molar mass and a lower functionality than the polyester polyol PES-A. It is essential that the second step is carried out without application of vacuum so that no reactant is entrained out. The functionality of the polyester polyol PES-B may therefore be safely adjusted with this two-step synthesis process.

Monools suitable for step b) of the abovementioned processes are therefore those having a boiling point at atmospheric pressure of at least 125° C., preferably at least 140° C. and very particularly preferably at least 165° C. The monools are preferably selected from the group consisting of 1-octanol, 2-octanol, 3-octanol, 4-octanol, 2-ethyl-1-hexanol, cis-2-hexen-1-ol, citronellol, 1-decanol, 1-dodecanol, 1-tetradecanol, 1-hexadecanol, 1-octadecanol, 1-tetracosanol, wherein saturated alcohols having primary hydroxyl groups and less than 12 carbon atoms, and also benzyl alcohol, are preferred. However it is also possible to use reaction products of the abovementioned monools and of relatively short chain monools, for example 1-hexanol, 1-butanol, 1-propanol, with alkylene oxides, preferably with ethylene oxide.

The number-average functionality of the obtained polyester polyol PES-B may be calculated as follows: The molar amounts of all reactant molecules involved in the process [n(reactant]), all reactive hydroxy groups [n(OH)_{reactant}] and the reactive carboxyl groups [n(carboxy)_{reactant}] of the reactants employed in step a)/step b) is calculated.

The molar sums of all hydroxy end groups and, separately, all carboxyl end groups of all reactant molecules are analogously calculated, wherein carboxylic anhydrides are included in the equation as having two COOH end groups and lactones as each having one hydroxyl end group and one carboxyl end group.

Calculating the difference between the (excess of) hydroxyl groups and the (deficiency of) carboxyl end groups [n(OH)_{reactant}−n(carboxy)_{reactant}] gives the number of hydroxyl end groups remaining in the polyester polyol PES-B, n(OH)_{PES-B}. Since during an esterification the number of reactant molecules is reduced by 1 with each esterification step (the water of reaction is discharged) there remains in the reaction vessel after all esterification steps, i.e. after complete reaction of the carboxyl groups (in the above mentioned sense), the following number of polyester molecules PES-B [n(PES-B)]:

n(reactants)−n(carboxy)_{reactant}=n(PES-B)

The number-average functionality F(OH)_{PES-B} of the polyester PES-B is thus:

F(OH)_{PES-B}=n(OH)_{PES-B}/n(PES-B)

In the context of the present invention this treatment disregards cyclic ester formation.

Catalysts may be used for both process steps. Suitable catalysts in principle include all catalysts that are known for the production of polyesters. These are for example tin salts, for example tin dichloride, titanates, for example tetrabutyl titanate or strong acids, for example p-toluene sulfonic acid. However, the polyester polyols may also be produced without the use of catalysts.

The hydroxyl number and thus also the number-average molar mass may be determined by end group titration according to DIN 53240 (December 1971). The acid number may be determined according to DIN EN ISO 2114 (June 2002). The equivalent mass is determined from the experimentally determined hydroxyl number (OHN) in mg KOH/g according to the well known formula M_{eq}=56100/OHN. Concerned here is a number-average equivalent mass which may be converted by multiplication with the OH functionality [F(OH)] into the number-average molar mass (Mₙ), i.e. Mₙ=F*M_{eq} or Mₙ=56100*F(OH)/OHN.

In the context of the present invention the functionality F(OH) relates to the hydroxyl end groups. Acid end groups are disregarded. As explained hereinabove F(OH) is defined as the number of OH end groups divided by the number of molecules in an ensemble. As mentioned hereinabove F(OH) normally results from the formulation with which the polyester polyol has been produced but may in principle or else alternatively be determined by ¹H-NMR or other colligative methods.

Monocarboxylic acids and derivatives thereof may also be added to the carboxylic acid (derivative) mixture C employed in step a). Also contemplated in particular are bio-based starting materials and/or derivatives thereof, for example castor oil, polyhydroxy fatty acids, ricinoleic acid, hydroxy-modified oils, grapeseed oil, black cumin oil, pumpkin kernel oil, borage seed oil, soybean oil, wheat germ oil, rapeseed oil, sunflower kernel oil, peanut oil, apricot kernel oil, pistachio oil, almond oil, olive oil, macadamia nut oil, avocado oil, sea buckthorn oil, sesame oil, hemp oil, hazelnut oil, primula oil, wild rose oil, safflower oil, walnut oil, fatty acids, hydroxyl-modified and epoxidized fatty acids and fatty acid esters, for example based on myristoleic acid, palmitoleic acid, oleic acid, vaccenic acid, petroselic acid, gadoleic acid, erucic acid, nervonic acid, linoleic acid, alpha- and gamma-linolenic acid, stearidonic acid, arachidonic acid, timnodonic acid, clupanodonic acid and cervonic acid. It will be appreciated that the acid groups/carboxy functions of these monocarboxylic acids must be accounted for in the calculation of the n(OH)_{reactant}/n(carboxy)_{reactant} ratio.

The polyester polyol PES-B produced with the process according to the invention may be aliphatic or else araliphatic. In a further preferred embodiment the proportion of aromatic groups may accordingly be 0% to 50% by weight, in particular 0% to <50% by weight, in each case based on the input materials, wherein especially mixtures of glutaric acid, succinic acid, adipic acid and/or phthalic acid and also ethylene glycol are employed. When aromatic groups are present the proportion thereof is >0% to 50% by weight. The aromatics proportion in the ester is calculated from the ester formulation by dividing the usage amount of aromatics-containing compound, i.e. for example phthalic anhydride and/or isophthic anhydride, by the amount of ester obtained.

In contrast to the previously employed single-step esterification process the process according to the invention allows reproducible production of the polyester polyols PES-B containing monools since the two-step nature of the process ensures complete reaction of the monool. In the context of the present patent application “reproducible” is to be understood as meaning that the functionalities and hydroxyl numbers may be reproducibly adjusted in an industrial sense for example in a range of +/−10%, preferably in a range of +/−5%. The polyester polyols PES-B have for example hydroxyl numbers of 150 to 300 mg KOH/g, preferably of 160 to 260, and for example number-average functionalities of <2.00, in particular 1.00 to 1.90, preferably of 1.20 to 1.80 and very particularly preferably of 1.30 to 1.79. Such polyester polyols cannot be reproducibly produced with the classical single-step synthesis process.

In a preferred embodiment the polyester polyol PES-B comprises 60 to 100 mol % of primary hydroxy groups but the process is also suitable for producing polyester polyols having less than 60 mol % of primary hydroxy groups.

The invention further provides for the use of the polyester polyols PES-B according to the invention in the production of rigid polyurethane foam products, for example polyurethane insulation sheets, metal composite elements, polyurethane block foam, polyurethane spray foam, polyurethane in-situ foams or else in one- or multi-component expanding foam or as a raw material for adhesives.

The invention further provides a reaction system for producing rigid PUR/PIR foams comprising the following components:
A) an organic polyisocyanate component;
B) a polyol component,
C) optionally auxiliary and additive substances and also blowing agents and co-blowing agents,

wherein the organic polyisocyanate component A) is employed in such a quantity ratio to the components B) and optionally C) that an index of 100 to 500 results, in particular 180 to 450, and the reaction system is characterized in that the polyol component B) comprises at least one polyester polyol PES-B according to the invention.

The index is to be understood as meaning the molar ratio of all NCO groups of the component A) to all NCO-reactive groups in the reaction system, i.e. in the present case the components B) and C).

The invention also provides for the use of the polyester polyols PES-B) according to the invention as or in the polyol component B) of a reaction system for producing rigid PUR/PIR foams.

Rigid PUR/PIR foams are to be understood as meaning rigid polyurethane foams containing polyisocyanurate-modified urethane structures. Such a reaction system for rigid PUR/PIR foams is preferably suitable for the production of rigid polyurethane foam products, for example polyurethane insulation sheets, metal composite elements, polyurethane block foam, polyurethane spray foam, polyurethane in-situ foams or else in one- or multi-component expanding foam or as a raw material for adhesives.

Suitable organic polyisocyanate components in principle include aliphatic, cycloaliphatic, araliphatic, aromatic and heterocyclic polyisocyanates, such as are described for example by W. Siefken in Justus Liebigs Annalen der Chemie, 562, pp. 75-136, for example those of formula

Q(NCO)ₙ

wherein n=2-4, preferably 2-3, and Q represents an aliphatic hydrocarbon radical having 2-18, preferably 6-10, carbon atoms, a cycloaliphatic hydrocarbon radical having 4-15, preferably 5-10, carbon atoms, an aromatic hydrocarbon radical having 6-15, preferably 6-13, carbon atoms or an araliphatic hydrocarbon radical having 8-15, preferably 8-13, carbon atoms, such as for example polyisocyanates as described in DE-OS 2.832.253, pp. 10-11.

Preference is normally given to polyisocyanates that are industrially easily obtainable, for example 2,4- and 2,6-tolylene diisocyanate (TDI) and mixtures of these isomers. Polyphenyl polymethylene polyisocyanates, for example those obtained by aniline-formaldehyde condensation and subsequent treatment with phosgene (crude MDI), and polyisocyanates comprising carbodiimide, urethane, allophanate, isocyanurate, urea or biuret groups (modified polyisocyanates), in particular those modified polyisocyanates that are derived from 2,4- and/or 2,6-tolylene diisocyanate and from 4,4′- and/or 2,4′-diphenylmethane diisocyanate.

The organic polyisocyanate component for producing rigid PUR/PIR foams preferably comprises mixtures of isomers of diphenylmethane diisocyanate (MDI) and its oligomers. Mixtures of this type are generally referred to as “polymeric MDI” (pMDI).

The polyol component contains at least one polyester polyol according to the invention and may in addition also comprise further polyol components. By way of such further polyol components there may be used at least one aliphatic polyester polyol which in addition to structural units derived from adipic acid also contains structural units derived from glutaric acid, succinic acid and/or phthalic acid, preferably glutaric acid and/or phthalic acid.

In addition to the further aliphatic polyester polyols the polyol component may further comprise compounds having isocyanate-reactive hydrogen atoms other than polyester polyols, for example polyether polyols or low molecular weight chain extenders or crosslinkers These additions can improve the flowability of the reaction mixture and the emulsifiability of the blowing agent-containing formulation.

The polyol component B) may be admixed with flame retardants, preferably in an amount of 5% to 50% by weight, based on the total amount of compounds having isocyanate-reactive hydrogen atoms in the polyol component, in particular 7% to 35% by weight, particularly preferably 12% to 25% by weight. Flame retardants of this type are known in principle to a person skilled in the art and are described for example in “Kunststoffhandbuch”, volume 7 “Polyurethane”, chapter 6.1. These may be, for example, brominated and chlorinated polyols or phosphorus compounds such as the esters of orthophosphoric acid and of metaphosphoric acid, which may likewise contain halogen. It is preferable to choose flame retardants that are liquid at room temperature.

Sufficient blowing agent and co-blowing agent is used as is required for achieving a dimensionally stable foam matrix and the desired apparent density. The proportion may be, for example, from 0% to 6.0% by weight of co-blowing agent and from 1.0% to 30.0% by weight of blowing agent, in each case based on 100% by weight of polyol component. The mixing ratio of co-blowing agent to blowing agent may be in the range from 20:1 to 0:100 as desired.

The blowing agents used are hydrocarbons, for example the isomers of pentane, or hydrofluorocarbons, for example HFC 245fa (1,1,1,3,3-pentafluoropropane), HFC 365mfc (1,1,1,3,3-pentafluorobutane) or their mixtures with HFC 227ea (heptafluoropropane). Different blowing agent classes may also be combined. Thus, for example, mixtures of n- or c-pentane with HFC 245fa in a ratio of 75:25 (n-/c-pentane:HFC 245fa) give thermal conductivities measured at 10° C. of less than 20 mW/mK.

Also employable as the co-blowing agent are water and/or formic acid, preferably in an amount of up to 6% by weight, preferably 0.5% to 4% by weight, based on the total amount of compounds having isocyanate-reactive hydrogen atoms in the polyol component. However, it is also possible to use no water.

The polyol component is advantageously admixed with catalysts customary in polyurethane chemistry. The amine catalysts needed for producing a rigid PUR/PIR foam and also the salts used as trimerization catalysts are used in an amount such that, for example, continuous production lines can produce elements having flexible outer layers at speeds up to 60 m/min, depending on element thickness, and that insulation on pipes, walls, roofs and also tanks and in refrigerators can be produced in the spray foam process with sufficient cure time. Discontinuous production is also possible.

Examples of such catalysts are: triethylenediamine, N,N dimethylcyclohexylamine, tetramethylenediamine, 1-methyl-4-dimethylaminoethylpiperazine, triethylamine, tributylamine, dimethylbenzylamine, N,N′,N″-tris(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl)urea, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N-dimethylaminopropyl)-s-hexahydrotriazine, tetramethylammonium hydroxide, sodium acetate, sodium octoate, potassium acetate, potassium octoate, sodium hydroxide or mixtures thereof.

Foam stabilizers may further be added to the polyol component, especially polyether siloxanes. The construction of these compounds is generally such that a copolymer of ethylene oxide and propylene oxide is attached to a polydimethylsiloxane radical. Substances of this type are commercially available, for example as Struksilon 8031 from Schill+Seilacher or else TEGOSTAB® B 8443 from Evonik. Silicone-free stabilizers, such as for example LK 443 from Air Products, may also be employed.

In a preferred embodiment of the reaction system according to the invention the weight ratio between the components A) and B) is from 100:150 to 100:300, in particular from 100:180 to 100:250.

The polyester polyols produced with the process according to the invention PES-B are especially suitable for use in rigid PUR-PIR foam formulations. The rigid PUR/PIR foams produced with the polyester polyols exhibit a combination of good fire safety properties and mechanical properties.

The invention further provides a process for producing rigid PUR/PIR foams, wherein the components A) and B) and optionally C) of a reaction system according to the invention are mixed and reacted.

The rigid PUR/PIR foams according to the invention are typically produced by one-step processes known to those skilled in the art in which the reaction components are continuously or discontinuously reacted with one another and then subsequently introduced either manually or with the aid of mechanical equipment in the high-pressure or low-pressure process after discharging onto a conveyor belt or into suitable molds for curing. Examples are described in U.S. Pat. No. 2,764,565, in G. Oertel (ed.) “Kunststoff-Handbuch”, Volume VII, Carl Hanser Verlag, 3rd edition, Munich 1993, pages 267 ff., and in K. Uhlig (ed.) “Polyurethan Taschenbuch”, Carl Hanser Verlag, 2nd edition, Vienna 2001, pages 83-102.

The invention additionally provides a rigid foam obtainable by mixing and reacting the components A) and B) and optionally C) of a reaction system according to the invention.

A rigid foam of this type can be used in various fields of application, especially as an insulating material. Examples from the field of building engineering are wall insulation, pipe shells and/or half-shells, roof insulation, wall elements and flooring panels. In particular, the rigid foam may be in the form of an insulation sheet or in the form of a composite element having flexible or inflexible outer layers and have a density of 25 to 65 kg/m³, in particular 30 to 45 kg/m³. In another embodiment the rigid foam may be in the form of a block foam and have a density of 25 to 300 kg/m³, in particular 30 to 80 kg/m³.

The invention also provides laminates containing the rigid PUR/PIR foams of the invention. These laminates have a core comprising rigid PUR/PIR foam according to the invention and outer layers firmly bonded thereto. The outer layers may be flexible or rigid. Examples are paper type outer layers, nonwoven type outer layers, metal type outer layers (for example steel, aluminum) and composite type outer layers. The outer layers are unwound from a roll and optionally profiled, optionally heated and optionally corona-treated to improve the foam-coatability of the outer layers. A primer may additionally be applied to the lower outer layer before application of the rigid polyisocyanurate foam system.

The production of laminates of this type is known in principle to a person skilled in the art and described for example in G. Oertel (ed.) “Kunststoff-Handbuch”, volume VII, Carl Hanser Verlag, 3rd edition, Munich 1993, pp. 272-277. It is preferably carried out according to the double conveyor belt process, wherein the laminates according to the invention are readily obtainable at belt speeds up to 60 m/min. The laminates produced from the PUR/PIR foams according to the invention show particularly good adhesion, especially in long-term testing.

### EXAMPLES

The experiments marked with an * denote comparative examples.

Raw Materials and Methods:
TCPP trischloroisopropyl phosphate (Levagard PP®, Lanxess AG), flame retardant
TEP Levagard® TEP, Lanxess AG, flame retardant, triethyl phosphate
Cat-1 Desmorapid® DB, Covestro Deutschland AG, is an activator for the production of rigid polyurethane (PUR) foams based on a tertiary amine
B 8443 TEGOSTAB® B 8443 from Evonik is a non-hydrolyzable polyether-polydimethylsiloxane copolymer
Cat-2 Desmorapid® 1792, Covestro Deutschland AG.
   Preparation containing diethylene glycol and potassium acetate.
   Trimerization catalyst.
B-1 polyether polyol based on ortho-toluenediamine, ethylene oxide and propylene oxide having an OH number of 415 mg KOH/g from Covestro Deutschland AG, viscosity at 25° C. about 8000 mPas.
B-2 polyester polyol composed of phthalic anhydride and diethylene glycol, OH number 795 mg KOH/g, from Covestro Deutschland AG, viscosity 160 mPas at 25° C., acidity 97 mg KOH/g.
PES-B1* bifunctional polyester polyol composed of technical grade glutaric acid and ethylene glycol from Covestro Deutschland AG for production of rigid PUR/PIR foams having a hydroxyl number of about 240 mg KOH/g, an acid number of about 1.75 mg KOH/g and a viscosity at 20° C. of 15590 mPa·s.
A-1 Desmodur®44V70L, polymeric MDI from Covestro Deutschland AG having an NCO content of 30.5% to 32% by weight
Glutaric acid, techn. Lanxess AG
Benzoic acid Acros
1-Decanol abcr GmbH
Ethylene glycol INEOS AG
n-Pentane Kraemer & Martin GmbH

The analyses were conducted as follows:

Dynamic viscosity: MCR 51 Rheometer from Anton Paar in accordance with DIN 53019 with a CP 50-1 cone, diameter 50 mm, angle 1° at shear rates of 25, 100, 200 and 500 The inventive and non-inventive polyester polyols exhibit viscosity values that are independent of the shear rate. Hydroxyl number: in accordance with the standard DIN 53240 (December 1971)

Acid number: in accordance with the standard DIN EN ISO 2114 (June 2002)

Mechanical properties were determined by means of a tensile test according to EN1607 (DIN EN 14509), May 2013 version, wherein the force was applied perpendicularly to the outer layer, i.e. in the foaming direction. These measurements give the parameter elastic modulus (also known as Young's modulus).

Also performed was a compression test in the foaming direction according to DIN EN 826 (May 2013 version) which likewise gave the parameter elastic modulus (also known as Young's modulus).

Also performed was a compression test perpendicular to the foaming direction according to DIN EN 826 (May 2013 version) which likewise gave the parameter elastic modulus (also known as Young's modulus).

Fire properties were determined according to DIN 4102-1 (May 1998 version), wherein the maximum flame height and the destroyed specimen length are in each case determined as measured values for five individual specimens.
Apparent density: determined according to DIN EN ISO 845 (October 2009 version).
Open-cell content according to DIN EN ISO 4590 (June 2014 version)
Cream time: The period elapsing from the start of mixing of the main components to visible commencement of foaming of the mixture.
Fiber time: The fiber time (“gel point t_{G}”) is determined by dipping a wooden rod into the reacting mixture and withdrawing it again. It characterizes the time from which the mixture begins to harden. Reported as t_{G} is the time at which it first becomes possible to draw fibers between the wooden stick and the reacting mixture. The time measurement starts with the mixing of the foam components.
Tack-free time: Shortly after the fiber time has been reached, a wooden stick is used at short time intervals to test the foam surface. The tack-free time, measured from the start of the mixing procedure, is reached when the wooden stick is released from the foam surface without difficulty and without any adhering product.

Functionality is calculated by reference to the functionality of the employed reactants.

1. Production of the Polyester Polyols

### Polyester Polyol PES-B2*

A 4 liter four-neck flask fitted with a mechanical stirrer, 50 cm random-packed column, thermometer, nitrogen inlet and also a column head, distillation bridge and vacuum membrane pump was initially charged with 1797 g (13.41 mol, 56.15% by weight) of technical grade glutaric acid, 188 g (1.54 mol, 5.88% by weight) of benzoic acid and 1215 g (19.57 mol, 37.97% by weight) of ethylene glycol and this initial charge was heated to 200° C. under a nitrogen blanket over the course of 60 min to distill off water of reaction; this distillate was monophasic and had a pH of 7. After 5 hours the pressure was slowly reduced to 200 mbar over the course of 3 hours. The mixture was reacted under these conditions for 40 hours and the OHN and the acid number were found to be 176 mg KOH/g and 1.1 mg KOH/g respectively. Discharged ethylene glycol (57.6 g) was replenished and stirred in at 160° C. at atmospheric pressure for a further 6 hours.

Analysis of the Polyester PES-B2*:
Hydroxyl number: 209.8 mg KOH/g
Acid number: 0.9 mg KOH/g
Viscosity: 1000 mPas (25° C.)
Functionality: 1.75

### Polyester Polyol PES-B3*

a) A 4 liter four-neck flask fitted with a mechanical stirrer, 50 cm random-packed column, thermometer, nitrogen inlet and also a column head, distillation bridge and vacuum membrane pump was initially charged with 1661 g (12.40 mol, 51.91% by weight) of technical grade glutaric acid, 381 g (3.13 mol, 11.93% by weight) of benzoic acid and 1157 g (18.65 mol, 36.20% by weight) of ethylene glycol and this initial charge was heated to 200° C. under a nitrogen blanket over the course of 60 min to distil off water of reaction. After 5 hours the pressure was slowly reduced to 200 mbar over the course of 3 hours. The mixture was reacted under these conditions for 40 hours; the distillates were monophasic and had a pH of 7. The OHN and the acid number were found to be 154.4 mg KOH/g and 1.4 mg KOH/g respectively. Discharged ethylene glycol (42.4 g, 0.68 mol) was replenished and stirred in at 200° C. at atmospheric pressure for a further 6 hours.

Analysis of the Polyester B-3*:
Hydroxyl number: 179.2 mg KOH/g
Acid number: 1.23 mg KOH/g
Viscosity: 1010 mPas (25° C.)
Functionality: 1.50

### Polyester Polyol PES-B4

a) A 4 liter four-neck flask fitted with a mechanical stirrer, 50 cm random-packed column, thermometer, nitrogen inlet and also a column head, distillation bridge and vacuum membrane pump was initially charged with 1680 g (12.54 mol) of technical grade glutaric acid and 1045 g (16.83 mol) of ethylene glycol and this initial charge was heated to 200° C. under a nitrogen blanket over the course of 60 min to distill off water of reaction. After 3 hours the pressure was slowly reduced to 30 mbar over the course of 3 hours. The mixture was reacted under these conditions for 24 hours. The OHN and the acid number were found to be 159.8 mg KOH/g and 0.5 mg KOH/g respectively. Discharged ethylene glycol (74 g, 1.19 mol) was replenished and stirred in at 200° C. at atmospheric pressure for a further 6 hours. The OHN and the acid number were found to be 210.2 mg KOH/g and 0.47 mg KOH/g respectively.
b) 227 g (1.43 mol) of 1-decanol was subsequently added and the mixture was stirred at 200° C. at atmospheric pressure for 6 hours.

Analysis of the Polyester PES-B4:
Hydroxyl number: 219.9 mg KOH/g
Acid number: 0.5 mg KOH/g
Viscosity: 580 mPas (25° C.)
Functionality: 1.75

### Polyester Polyol PES-B5*, Comparative Example

A 4 liter four-neck flask fitted with a mechanical stirrer, 50 cm random-packed column, thermometer, nitrogen inlet and also a column head, distillation bridge and vacuum membrane pump was initially charged with 1367 g (10.21 mol) of technical grade glutaric acid, 826 g (13.30 mol) of ethylene glycol and 490 g (3.1 mol) of 1-decanol and this initial charge was heated to 200° C. under a nitrogen blanket over the course of 60 min to distill off water of reaction which was cloudy and subsequently separated into two phases. After 3 hours the pressure was slowly reduced to 250 mbar over the course of 2 hours. The mixture was reacted under these conditions for 15 hours and further water of reaction forming two phases was separated. The OHN and the acid number were found to be 145.9 mg KOH/g and 1.3 mg KOH/g respectively.

The biphasic nature of the water of reaction indicates that it contains proportions of 1-decanol; it is known from the examples A-4, PES-B3 and PES-B2 that ethylene glycol is also discharged under these conditions. 1-Decanol is known to be only slightly soluble in water (about 40 mg/1). However, since the water phase also contains ethylene glycol certain proportions of 1-decanol are presumably dissolved in the ethylene glycol-containing water phase just as certain proportions of ethylene glycol are present in the 1-decanol phase. Since adjustment of the functionality of the polyester polyol absolutely requires precise knowledge of the distillatively removed amounts and correspondingly replenishable amounts of ethylene glycol and 1-decanol but these are only experimentally determinable at great complexity, the batch had to be disposed of A monool cannot reproducibly be reacted with diol in a single-step esterification in this way.

### Polyester Polyol PES-B6*, Comparative Example

A 4 liter four-neck flask fitted with a mechanical stirrer, 50 cm random-packed column, thermometer, nitrogen inlet and also a column head, distillation bridge and vacuum membrane pump was initially charged with 1124.5 g (8.39 mol) of technical grade glutaric acid, 279.8 g (0.99 mol) of oleic acid and 1445.2 g (13.6 mol) of diethylene glycol and this initial charge was heated to 200° C. under a nitrogen blanket over the course of 60 min to distill off water of reaction. After 4 hours the pressure was slowly reduced to 100 mbar over the course of 3 hours. The mixture was reacted under these conditions for 24 hours. The OHN and the acid number were found to be 180 mg KOH/g and 0.7 mg KOH/g respectively. Discharged diethylene glycol (58 g, 0.55 mol) was replenished and stirred in at 200° C. at atmospheric pressure for a further 5 hours.

Analysis of the polyester PES-B6*:
Hydroxyl number: 199.4 mg KOH/g
Acid number: 0.9 mg KOH/g
Viscosity: 540 mPas (25° C.)

TABLE 1
Formulations and properties of inventive
and noninventive polyester polyols PES-B

| Example: | | PES-B2* | PES B3* | PES-B4 | PES-B6* |
|---|---|---|---|---|---|
| Formulation: | | | | | |
| Glutaric acid | [% by wt.] | 56.15 | 51.91 | 56.91 | 39.5 |
| Benzoic acid | [% by wt.] | 5.88 | 11.93 | | |
| Ethylene glycol | [% by wt.] | 37.97 | 36.17 | 35.4 | |
| Diethylene glycol | [% by wt.] | | | | 50.7 |
| 1-Decanol | [% by wt.] | | | 7.69 | |
| Oleic acid | [% by wt.] | | | | 9.8 |
| Properties: | | | | | |
| OH number | [mg KOH/g] | 209.8 | 179.2 | 219.9 | 199.4 |
| Acid number | [mg KOH/g] | 0.88 | 1.23 | 0.5 | 0.9 |
| Functionality, | | 1.75 | 1.5 | 1.75 | 1.8 |
| calculated | | | | | |
| Viscosity 25° C. | [mPa*s] | 1000 | 1010 | 580 | 540 |

2. Production of the Rigid PUR/PIR Foams:

Rigid PUR/PIR foams were produced on the basis of the above-described polyester polyols PES-B. To this end the respective polyester polyol PES-B according to table 2 was initially charged with the further polyols B-1 and B-2 and admixed with the flame retardant, a foam stabilizer based on polyether siloxane, catalysts and n-pentane as blowing agent, the mixture thus obtained was mixed with polyisocyanate A-1 and the mixture was poured into a wooden box mould open at the top (30×30×10 cm³) and allowed to fully react therein. The formulations and results of the physical measurements on the specimens obtained are shown in table 2.

TABLE 2
Production and properties of inventive and noninventive
(comparative, *) rigid PUR/PIR foams

| Example | | B-1* | B-2* | B-3* | B-4 | B-6* |
|---|---|---|---|---|---|---|
| Polvol component: | | | | | | |
| PES-B1* | [pts. by wt.] | 66.50 | | | | |
| PES-B2* | [pts. by wt.] | | 66.50 | | | |
| PES-B3* | [pts. by wt.] | | | 66.50 | | |
| PES-B4 | [pts. by wt.] | | | | 66.50 | |
| PES-B6* | [pts. by wt.] | | | | | 66.50 |
| TCPP | [pts. by wt.] | 20.80 | 20.80 | 20.80 | 20.80 | 20.80 |
| TEP | [pts. by wt.] | 5.20 | 5.20 | 5.20 | 5.20 | 5.20 |
| B-1 | [pts. by wt.] | 5.20 | 5.20 | 5.20 | 5.20 | 5.20 |
| B-2 | [pts. by wt.] | 2.30 | 2.30 | 2.30 | 2.30 | 2.30 |
| B8443 | [pts. by wt.] | 3.50 | 3.50 | 3.50 | 3.50 | 3.50 |
| Cat-1 | [pts. by wt.] | 1.50 | 1.50 | 1.50 | 1.50 | 1.50 |
| Cat-2 | [pts. by wt.] | 3.70 | 3.70 | 3.70 | 3.70 | 3.40 |
| n-Pentane | [pts. by wt.] | 16.50 | 15.50 | 14.60 | 15.50 | 16.70 |
| Isocvanate-side | | | | | | |
| formulation: | | | | | | |
| A-1 | [pts. by wt.] | 169.90 | 155.40 | 140.90 | 160.30 | 148.80 |
| Index | | 300 | 300 | 300 | 300 | 300 |
| Processing: | | | | | | |
| Cream time | [s] | 13 | 13 | 12 | 13 | 11 |
| Fiber time | [s] | 44 | 39 | 39 | 35 | 35 |
| Tack-free time | [s] | 60 | 56 | 60 | 50 | 55 |
| Properties: | | | | | | |
| Apparent density | [kg/m³] | 34.00 | 33.70 | 35.10 | 34.10 | 35.46 |
| Elastic modulus, | [N/mm²] | 13.23 | 11.16 | 12.24 | 12.67 | 11.79 |
| tensile test | | | | | | |
| perpendicular to | | | | | | |
| outer layer | | | | | | |
| Elastic modulus, | [MPa] | 9.76 | 8.31 | 8.10 | 7.79 | 7.40 |
| compression test | | | | | | |
| in foaming | | | | | | |
| direction | | | | | | |
| Elastic modulus, | [MPa] | 2.82 | 2.12 | 1.79 | 2.03 | 1.71 |
| compression test | | | | | | |
| perpendicular to | | | | | | |
| foaming direction | | | | | | |
| Fire safety class | | not met | met | met | met | met |
| B2 | | | | | | |
| Open-cell content | [%] | 7.70 | 11.10 | 9.00 | 11.10 | not |
| | | | | | | determined |

Table 2 shows that in terms of fire safety the rigid PUR-PIR foams based on the inventive polyols PES-B4 are markedly superior to the rigid PUR-PIR foam based on the noninventive polyol PES-B 1 and equivalent to the polyols PES-B2 and PES-B3. The substantial difference between the polyol PES-B4 and the noninventive polyol PES-B1 is merely the functionality of the employed polyester polyol. All other formulation constituents are identical in their usage amounts apart from the isocyanate amount, different isocyanate amounts being necessary to likewise keep the indices of all formulations identical at 300. The apparent densities of all foams are likewise within a very narrow window. In terms of processing characteristics, just as few large differences as for the mechanical properties are determinable. Closed-celled, fine-celled, dimensionally stable foams were obtained in all cases. PES-B4 is a good alternative to the known polyester polyols PES-B2 and PES-B3. The process according to the invention allows reproducible production of the polyester polyol PES-B4 and makes it possible to use monools for production of polyester polyols.

1. A multistage process for producing a polyester polyol PES-B comprising:
a) completely reacting at least one carboxyl compound selected from the group consisting of i) polyfunctional carboxylic acids and ii) polyfunctional hydroxy-reactive carboxylic acid derivatives selected from the group consisting of carbonyl chlorides, alkyl carboxylates, hydroxy-functional carboxylic acids, lactones and carboxylic anhydrides with at least one polyol containing 2-8 hydroxy groups to afford a polyester polyol PES-A,
wherein in step a) the ratio of the molar amount of employed hydroxyl groups [n(OH)ₐ] to the molar amount of carboxyl-equivalent groups [n(carboxy)ₐ] is:
n(OH)ₐ/n(carboxy)ₐ>1, and
b) subsequently reacting the polyester polyol PES-A obtained in step a) with a monofunctional alcohol to afford the PES-B,
wherein the ratio of the molar sum of the hydroxy groups n(OH)_{reactant} of all reactant molecules employed in steps a) and b) to the molar sum of the employed carboxyl-equivalent groups n(carboxy)_{reactant} is:
n(OH)_{reactant}/n(Carboxy)_{reactant}>1.

2. The process as claimed in claim 1, wherein the polyester polyol PES-B has a number-average OH functionality of >1.00 to <2.00.

3. The process as claimed in claim 1, wherein the carboxyl compound in step a) comprises glutaric acid, succinic acid, adipic acid, terephthalic acid, phthalic acid, isophthalic acid, a derivative of any thereof, or a combinations of any thereof.

4. The process as claimed in claim 1, wherein the at least one polyol in step a) comprises a polyol containing 2-3 hydroxy groups.

5. The process as claimed in claim 4, wherein the at least one polyol in step a) comprises a polyol containing 2 hydroxy groups.

6. The process as claimed in claim 1, wherein the monofunctional alcohol comprises 1-octanol, 2-octanol, 3-octanol, 4-octanol, 2-ethyl-1-hexanol, cis-2-hexen-1-ol, citronellol, 1-decanol, 1-dodecanol, 1-tetradecanol, 1-hexadecanol, 1-octadecanol, 1-tetracosanol, benzyl alcohol, or a combination thereof.

7. The process as claimed in claim 1, wherein the monofunctional alcohol comprises a reaction product of a monofunctional alcohol with an alkylene oxide.

8. A polyester polyol obtained by the method as claimed in claim 1.

9. The polyester polyol as claimed in claim 8 having a hydroxyl number of 150 to 300 mg KOH/g, and a number-average functionality of 1.00 to <2.00.

10. A rigid PUR/PIR foam containing the polyester polyol as claimed in claim 8.

11. A reaction system for producing a rigid PUR and PIR foam comprising:
A) an organic polyisocyanate component;
B) a polyol component
C) optionally auxiliary and additive substances, blowing agents and co-blowing agents,
wherein the organic polyisocyanate component A) is employed in such a quantity ratio to the components B) and optionally C) that an index of 100 to 500 results, and
the reaction system is characterized in that the polyol component B) comprises at least one polyester polyol as claimed in claim 9.

12. A process for producing a rigid PUR and PIR foam,
comprising mixing and reacting the reaction system as claim in claim 11.

13. A rigid PUR/PIR foam obtained by mixing and reacting the components A) and B) and optionally C) of the reaction system as claimed in claim 11.

14. The rigid foam as claimed in claim 13, wherein the rigid foam has a density of 25 to 65 kg/m³ and is in the form of an insulation sheet or in the form of a composite element having flexible or inflexible outer layers or wherein the rigid foam is in the form of a block foam having a density of 25 to 300 kg/m³.

15. The process as claimed in claim 7, wherein the alkylene oxide comprises ethylene oxide and the monofunctional alcohol comprises 1-hexanol, 1-butanol, 1-propanol, 1-octanol, 2-octanol, 3-octanol, 4-octanol, 2-ethyl-1-hexanol, cis-2-hexen-1-ol, citronellol, 1-decanol, 1-dodecanol, 1-tetradecanol, 1-hexadecanol, 1-octadecanol, 1-tetracosanol, benzyl alcohol, or a combination of any thereof.
